(19) United States
(12) Patent Application Publication
(10) Pub. No.: US 2007/0039215 A1
(43) Pub. Date: Feb. 22, 2007

(54) Reusable greeting card

(76) Inventor: Aidan John David Sheridan, London (GB)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 11/505,617

(22) Filed: Aug. 16, 2006

(30) Foreign Application Priority Data
Aug. 18, 2005 (GB) 0516939.6

(51) Int. Cl. G09F 1/00

(52) U.S. Cl. 40/124.01

(57) ABSTRACT

A reusable greeting card may include at least two message sections, each of the message sections configured to provide a medium for the addition of messages. A mechanism, defined on the greeting card, facilitates successive use of the card between two or more parties, such successive use presented in the card in a desired (chronological, non-chronological, random, etc.) sequence. A method of sending greetings includes providing a reusable greeting card having a plurality of designated message sections; and sending the card between two or more parties, each party adding a new message in an unused message section of the card before sending the card on, so that messages are presented in the card in the desired sequence.

### BACKGROUND

The present disclosure relates generally to greeting cards, and more particularly to reusable greeting cards.

Decorative greeting cards are normally used to send a message or a greeting from one person to another during festive or special occasions, such as Christmas, New Year's and Birthdays. Each card is used once, then stored away or disposed of once the special occasion has passed.

Most greeting cards are generally formed from a folded card which creates a 4 page booklet. A picture is normally printed on page 1 (the front of the card), page 2 is left blank, page 3 of the card is then used to write a message to the recipient, and page 4 is normally blank, except for the details of the publisher of the card.

More prestigious cards might have additional pages attached to the inside of the card to allow for more intricate designs. In most cases, the cards are designed to be used once, with no allowance to reuse the card. The current card market relies on society's throw-away culture, where a greeting card is seen as a disposable item once a special occasion has passed. The nature of traditional greeting cards is that the publisher provides a product 90% complete, and the user adds a personal note to the card before sending it to the recipient. Due to the standardized format of greeting cards, and the small commitment on the sender's part to personalize the card, there is very little perceived personal value in the card, which means a minority of people receiving greeting cards collect and store cards for nostalgic reasons.

The greeting card industry by nature is a fast moving business, with each design of card generally lasting one season (which is around 18 months). The subjects used to decorate the cards reflect the way society is developing, with designs influenced by what is happening in industries such as Fashion, Art and Entertainment. The buyers of cards will normally look for something that matches the character of the person or persons to whom they are sending the card(s). As such, the range of cards, and number of publishers are vast, with new designs and publishing companies joining the market each year, looking to secure a small share in the card market.

With the high numbers of card designs in the market place, the majority are not suitable for one particular individual's taste, therefore time is needed to be spent looking for cards for special friends and relatives. On some occasions, due to pressures of time, the card buyer may not have the time to look at all available card designs in the various card shops, and a compromise may be required in order to get a card to the recipient within a reasonable amount of time. In this situation, the sender has to choose a card closest to, but not necessarily his/her taste.

As such, it would be desirable to provide a card which may be suitable for a variety of tastes, while potentially aiding in lessening of waste from greeting cards.

### SUMMARY

A reusable greeting card may include at least two message sections, each of the message sections configured to provide a medium for the addition of messages. A mechanism, defined on the greeting card, facilitates successive use of the card between two or more parties, such successive use presented in the card in a desired (chronological, non-chronological, random, etc.) sequence. A method of sending greetings includes providing a reusable greeting card having a plurality of designated message sections; and sending the card between two or more parties, each party adding a new message in an unused message section of the card before sending the card on, so that messages are presented in the card in the desired sequence.

### BRIEF DESCRIPTION OF THE DRAWINGS

Features and advantages of embodiment(s) of the present disclosure will become apparent by reference to the following detailed description and drawings, in which like reference numerals correspond to similar, though not necessarily identical components. For the sake of brevity, reference numerals having a previously described function may not necessarily be described in connection with other drawings in which they appear.

FIG. 1a shows plan and perspective views of the cover of a traditional card;

FIG. 1b shows plan and perspective views of a four page insert sheet of a traditional card;

FIG. 1c shows perspective views depicting attachment of the insert sheets to a cover of a traditional card;

FIG. 2 shows plan and perspective views of a Booklet embodiment of a Reusable Greeting card of the present disclosure with two sets of four page insert sheets, specifically, FIG. 2a shows plan and perspective views of the cover of a Reusable Greeting card;

FIG. 2b shows plan and perspective views of a first four page insert;

FIG. 2c shows plan and perspective views of a second four page insert;

FIG. 2d shows perspective views of attachment of insert sheets to a cover;

FIG. 3a shows perspective views of the Booklet embodiment of the Reusable Greeting card, illustrating a six message section card;

FIG. 3b shows perspective views of the Booklet embodiment of the Reusable Greeting card, illustrating an eight message section card;

FIG. 3c shows perspective views of the Booklet embodiment of the Reusable Greeting card, illustrating a ten message section card;

FIG. 4a shows plan and perspective views of the Reusable Greeting card Booklet embodiment cover;

FIG. 4b shows plan views illustrating side 1 and side 2 of a sixteen page insert sheet;

FIG. 4c shows plan and perspective views illustrating insert sheet folding and attachment to a cover;

FIG. 5a shows plan views of an example of a sixteen page card (side 1 and side 2), Concertina fold embodiment of the Reusable Greeting card with an eight message section capacity;

FIG. 5b shows a perspective view illustrating how the card of FIG. 5a is folded;

FIG. 6a shows plan and perspective views of a cover with an aperture cut to display a picture; and

FIG. 6b shows a plan view of a cover with slots punched to hold a picture.

### DETAILED DESCRIPTION OF THE EMBODIMENTS

There has been a gradual change in the behavior of society, having made a conscious decision to recycle products and packaging. There is also a trend where people wish to collect memories in a personal and a tangible form, as mass production and the use of electronic mail has become a common form of correspondence, while hand written letters have become a rare article.

The present disclosure seeks to provide a greeting card that addresses these concerns. Accordingly, embodiment(s) of the present disclosure provide a reusable greeting card suitable for many different tastes and serving as a tangible medium for recordation of memories.

Embodiment(s) of the reusable greeting card of the present disclosure have been designed to answer the needs of today's society that wishes to cut down on waste, while creating a vehicle for developing memorabilia to cherish in much the same way people build up photograph albums. The reusable greeting card of the present disclosure provides a very effective alternative to the standard, mass produced cards published by the card industry, allowing the user to create customized cards which can be used for more than one occasion. The reusable nature of the card also means there will be less of a need to go out to buy a new card for every occasion, thus saving the user's time, effort and, ultimately, money.

Reusable greeting cards according to embodiment(s) herein advantageously achieve one or more of the following goals (1) enable the user of the card to send a greeting or message more than once; (2) provide an attractive vehicle to carry multiple messages and images; (3) substantially ensure there is a progressive and clear method of recording the greetings in a desired sequence (chronological, non-chronological, random, etc.); (4) provide an optional space for imagery to accompany the written messages; (5) made of suitable material to accommodate the reusable nature of the card; (6) provide a new form of card which allows two or more parties to develop a date/time sensitive diary and image library; (7) reduce the waste of cards which are disregarded due to their perceived lack of importance and value; (8) reduce the effort of the client in trying to find a suitable card each year; (9) enable each sender to create a unique card commercially unavailable presently; (10) and save the user money. While embodiment(s) of the Reusable Greeting card of the present disclosure may, in some instances, be more expensive than a single traditional card, it will actually replace several traditional cards, thus saving money in the long term.

Traditional greeting cards generally display a certain level of decoration, and the reusable greeting card(s) will be presented in a number of forms to provide different levels of decoration to suit the client's needs. The most basic designs will feature minimal printed graphics to guide the user on how to use the card. The basic form will require the user to add their own pictures or graphics to the cover of the card and specified places throughout the card. There will also be a minimal amount of wording to support the theme of the greeting, such as “Happy Christmas & Happy New Year.” On the more decorative cards, there will be far more pictures and wording added to allow for the minimum of input from the user. Due to the trends for creating collections of memorabilia, the basic design is considered to be a favored format.

There will be various methods of adding pictures to the reusable greeting card according to embodiment(s) of the present disclosure. In some cases, there may be pre-cut slots to hold four corners of a picture of a specific size; while in other cases, there may be a need to use an alternative method of affixing pictures, such as glue or tape.

The reusable greeting card can be used in ways other than sending seasonal and event sensitive messages. The card can be produced with a very general set of printed details, which will allow the user to choose how he/she wishes to use the card. In this form, it could be used by people who normally write to each other on a regular basis, and will thus allow them to see their stories develop.

In an embodiment, the reusable greeting card(s) may be sent with conventional method(s), and therefore will fit into an envelope. A cost effective method would be to design the card(s) to fit standard size envelopes.

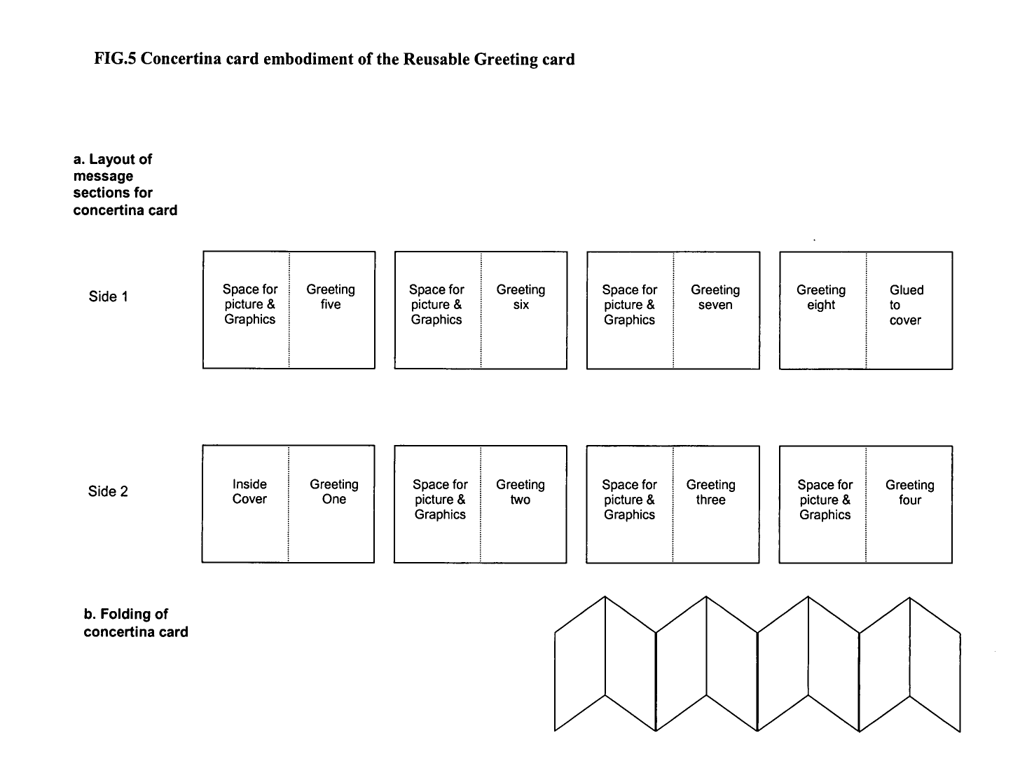

There are a number of embodiment(s) of the card of the present disclosure, some non-limitative examples of which are as follows: a booklet style with four page insert pages; a booklet style with multi-fold insert pages; and Concertina folded. “Concertina” is a method of folding in which each fold opens in the opposite direction to its neighbor, giving a pleated effect (see, for example, FIG. 5b).

An example of the Booklet embodiment has four page inserts, made up of a cover created from a folded sheet of card, creating a four page cover. Additional insert pages, made up of folded sheets of card, may be added to the inside spine of the cover, creating pages of the book.

The multi-fold insert page embodiment, in an example, is created from one sheet of card folded several times. Whichever format of pages is used, this section of the card is fixed to the inside spine of the card cover in a traditional method such as staples, glue and string, with the aim of substantially ensuring that the order of the pages remain intact over the life of the card.

In example(s) of the Concertina folded embodiment, a long, relatively thin piece of card is folded to create separate sections to accommodate each generation of message.

Due to its structure, the Booklet embodiment may, in some instances, lend itself better to the purpose of the progressive nature of a reusable card, as it begins to read as a book as more information is stored.

The number of pages added to the booklet generally dictates the capacity of the booklet embodiment. Each additional set of 4 pages will provide two double page sections designed to accept pictures and messages. Each time the card is used, the sender fills in one message section, attaching pictures or graphics if desired. The card may be filled using the traditional structure of a book, i.e. front to back, left page to right page.

The capacity of the cards is built up in four page sections; therefore the minimum capacity is two message sections. The intention is that the original sender will always end up with the card once all message sections have been used. To achieve this, cards will have the capacity in even numbers of message sections. The capacity of the booklet version with a multi-fold page section may be dictated by the size of sheet of card used and the method of folding, the simplest being folded four times to create eight message sections.

When considering the Concertina folded embodiment, the number of uses may be dictated simply by the number of folds, every additional two folds creating a new message section.

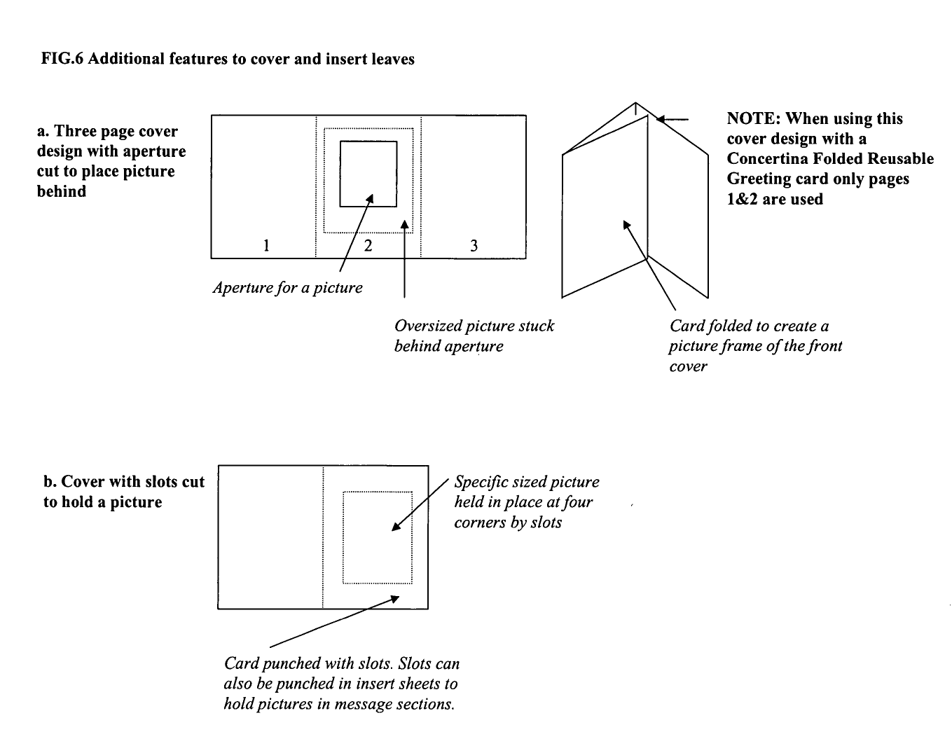

Additional features can be added to the cover designs and used with all embodiments of the Reusable Greeting disclosed herein. Two non-limitative examples of such additional features include a three page cover with an aperture cut to provide a frame for an added picture (see, for example, FIG. 6a); and four picture retaining slots punched to hold a picture (see, for example, FIG. 6b).

The slots punched in the cover design may also be added to insert pages, enabling the user to add pictures throughout the card in message sections, where space is provided for pictures or graphics.

The Reusable Greeting card according to embodiment(s) of the present disclosure enables a single card to be successively used more than once, by more than one person (an example of which is to be sent back and forth between two parties), to send a message or greeting, the message generally including a history of past greetings in a desired sequence (chronological, non-chronological, random, etc.). In an embodiment of the reusable greeting card described herein, the card is configured so that successive messages are added to the card in chronological sequence. Embodiment(s) of the Reusable Greeting card of the present disclosure may be designed attractively, with a well-organized structure. Each time the card is used, the new sender adds a message and pictures or graphics in the next available message section in the card.

The look of the present card(s) is flexible, thus providing the customer with, at one extreme, a virtually blank card with only guidance on where to write greetings and place pictures. At the other extreme, the customer may be provided with a fully illustrated version which requires the sender to minimally contribute to the content of the card, e.g., in some cases, only a short message would be required each time.

The Reusable Greeting card is designed to provide a structured method of recording messages and images over a long period to create a unique form of memorabilia, generally created by both the sender and recipient of the cards.

Due to the personal nature of the Reusable greeting card, the more times the card is used, the more valuable it becomes in terms of the content within the card, thus creating a unique item with nostalgic value for the sender. Through this feature, the Reusable Greeting card aims to reduce the number of cards that are discarded out of lack of importance, therefore reducing waste.

Embodiment(s) of the Reusable Greeting card allow the user to put much more effort into the design of the card, therefore creating a very unique card. This approach is meant to enable the user to reduce the need to search for existing published cards for designs that match their exact requirements but gives them the platform to build their own. This will save on time and disappointment when the correct card cannot be found.

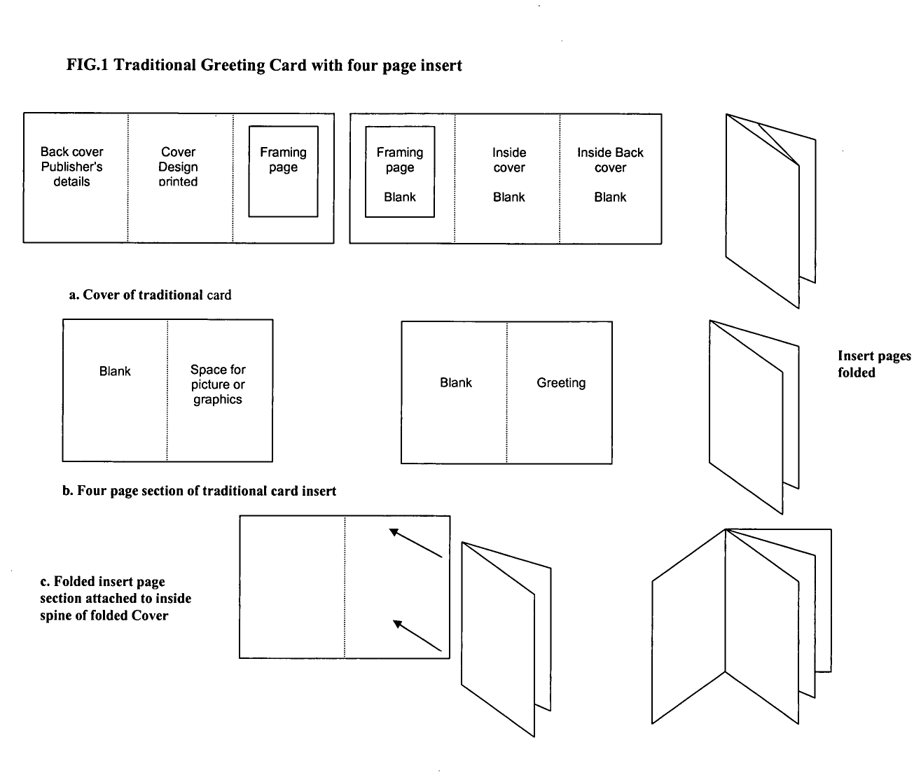

Referring now to FIGS. 1a-1c, there is shown an example of a traditional card that has a four page insert section that is used to write the greeting. This design is used for more expensive cards, with the insert sheet section attached to the card cover with traditional methods such as gluing or tied with a string.

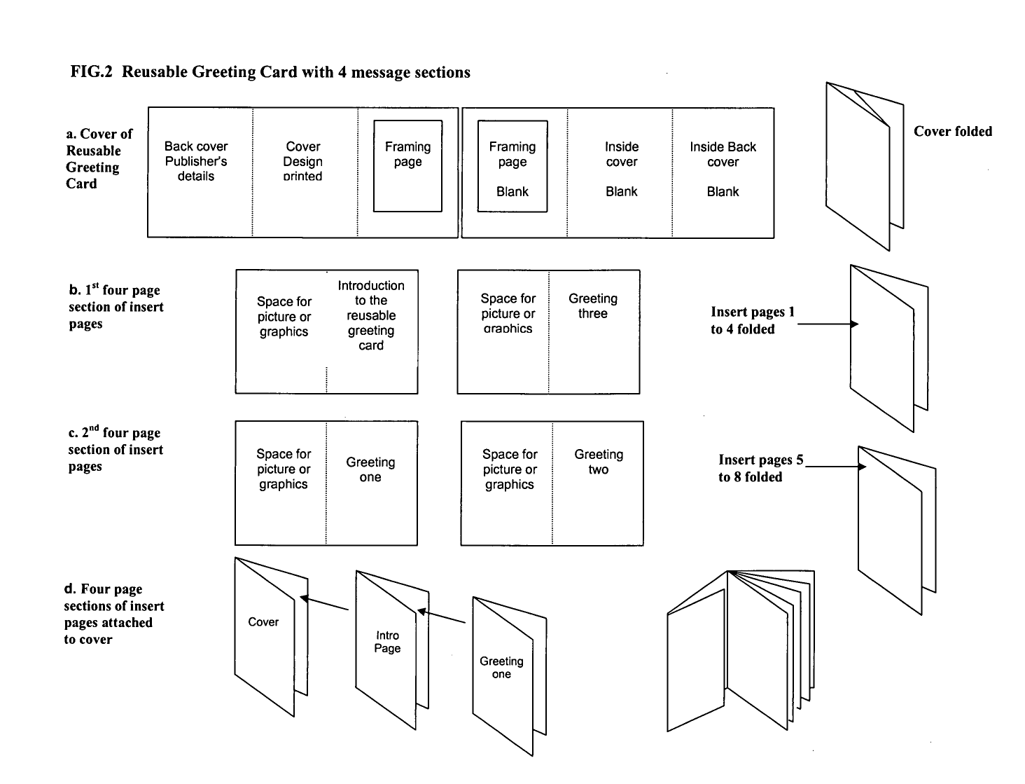

FIGS. 2a -2d show an embodiment of the Reusable Greeting card with the capacity of 4 message sections, made up of a four page cover and two sets four insert pages. The pages are arranged in the format in which they will be printed, which requires one page of the cover being used for part of the fourth message section. FIG. 2a shows the cover layout, which may be similar to the layout of a standard card; however, “Greeting four” appears where a standard greeting would appear. FIGS. 2b and 2c show the message sections and a page dedicated to an introduction that explains how the card is used. FIG. 2d shows both sets of insert pages being attached to the spine of the card cover, using traditional methods such as glue or staples.

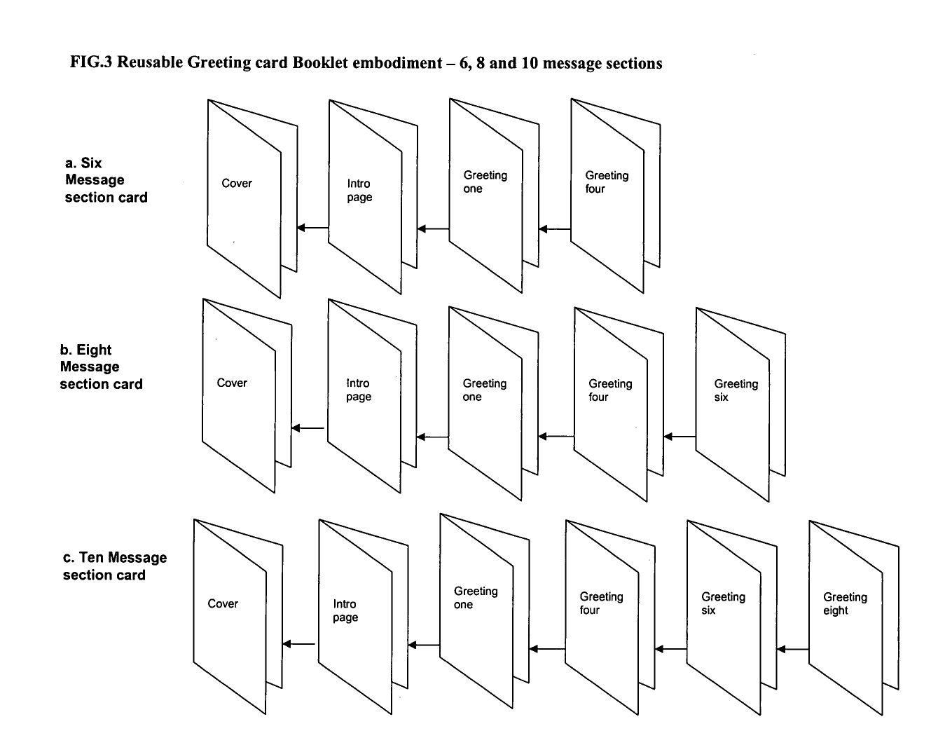

FIGS. 3a -3c show additional versions of embodiment(s) of the Booklet style of Reusable Greeting card, which have a greater capacity than four messages sections. With each additional section of four page insert pages, there are two additional message sections. FIGS. 3a, 3b and 3c show Reusable Greeting cards with the capacity of 6, 8 and 10 message sections, respectively.

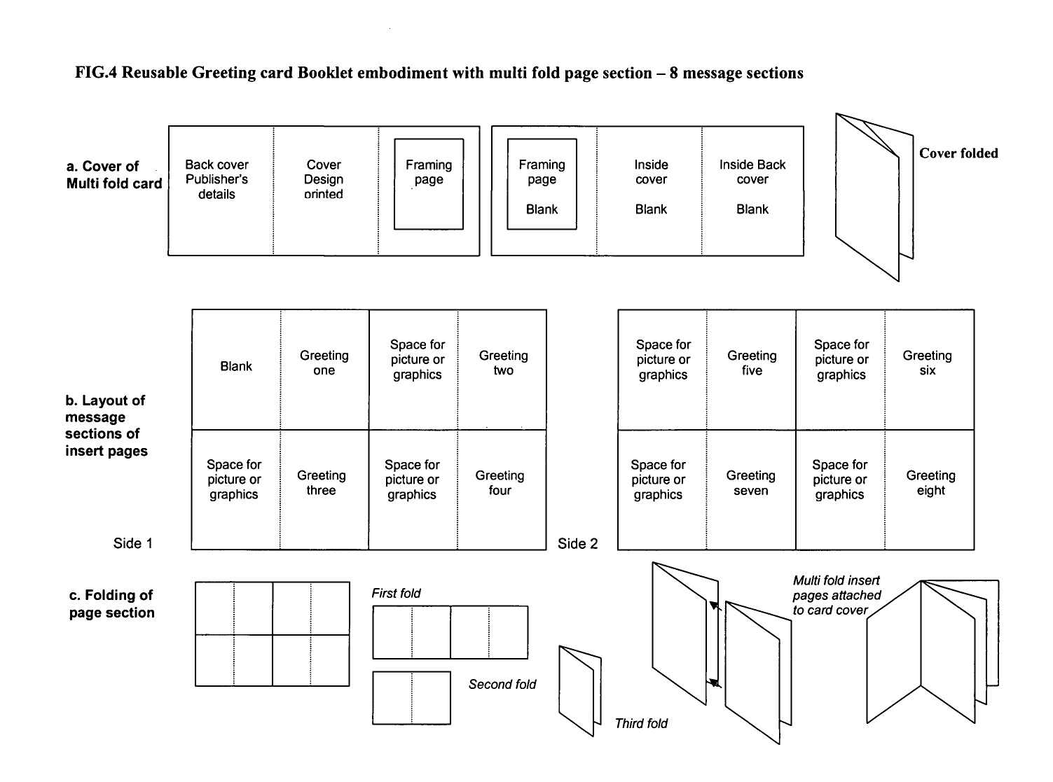

FIGS. 4a -4c show another embodiment of the Reusable Greeting card, which is a Booklet style with a multi-folded insert page section, which carries eight message sections. FIG. 4a shows the cover layout, which may be similar to a basic traditional greeting card. FIG. 4b shows two sides of a sheet of message sections, once again laid out in the format in which they would be printed. FIG. 4c shows how the sheet of message sections would be folded and attached to the card cover, using traditional methods such as glue or staples.

FIGS. 5a -5b show another embodiment of the Reusable Greeting card, which is a Concertina folded format. The capacity of the card shown has space for eight message sections. FIG. 5a shows the layout of both sides of a single piece of narrow card, laid out as it would be printed. This embodiment of the Reusable Greeting card does not require a cover separate from the insert pages, as the differentiation between the cover and message sections is achieved through simply folding the card with the method illustrated in FIG. 5b.

FIGS. 6a -6b show examples of additional cover designs that can be used in all embodiments of the Reusable Greeting Card of the present disclosure. FIG. 6a shows a three page front cover, which is designed to provide the user with a frame in which to place a picture. This is achieved by cutting an aperture in page 2 of the card cover. The picture is attached to the card around the aperture with a method such a cellotape or glue. Page 3 is then folded behind and attached, e.g., with glue to page 2.

FIG. 6b shows a cover design with slots punched in four locations, which are designed to hold four corners of a picture. The message sections within a card could also be punched with four slots to enable the sender to add pictures each time a new message section is filled in.

While several embodiments have been described in detail, it will be apparent to those skilled in the art that the disclosed embodiments may be modified. Therefore, the foregoing description is to be considered exemplary rather than limiting.

What is claimed is:

1. A reusable greeting card, comprising:
a plurality of message sections, each message section configured to provide a medium for the inscription of messages, said message sections further configured to enable the card to be used more than once, wherein two or more parties may pass the card between themselves, adding a new message in an unused message section each time before sending the card on so that messages are presented in the card in a chronological sequence.

2. The reusable greeting card according to claim 1 wherein at least one of the plurality of message sections is further configured to provide for the attachment of at least one of graphics or pictures.

3. The reusable greeting card according to claim 1, further comprising a folded cover and pages to accommodate designated message sections.

4. The reusable greeting card according to claim 1 wherein instructions are printed on a part of the card to guide a user in using the card.

5. The reusable greeting card according to claim 1, further comprising a cover and separate message sections.

6. The reusable greeting card according to claim 5 wherein the cover is made up of a four page design.

7. The reusable greeting card according to claim 1 wherein the message sections are provided in four-page sections, each section providing space for two messages.

8. The reusable greeting card according to claim 1, further comprising one or more additional message sections added to the card to provide further space for the inscription of messages.

9. The reusable greeting card according to claim 8 wherein the one or more additional message sections comprise a four-page message section.

10. The reusable greeting card according to claim 5 wherein the cover and message sections are attached to create a booklet card.

11. The reusable greeting card according to claim 1, further comprising a three page cover design providing a photographic frame to add a picture or graphics.

12. The reusable greeting card according to claim 5 wherein the cover incorporates punched slots to hold a picture or graphics in place.

13. The reusable greeting card according to claim 1 wherein at least some of the message sections incorporate punched slots to hold at least one of a picture or graphics in place.

14. The reusable greeting card according to claim 1 wherein the card is formed from a sturdy material suitable for repeated use.

15. A reusable greeting card, comprising:
at least two message sections, each of the at least two message sections configured to provide a medium for the addition of messages; and
means, defined on the greeting card, for facilitating successive use of the card between two or more parties, such successive use presented in the card in a desired sequence.

16. A method of sending greetings, comprising the steps of:
providing a reusable greeting card having a plurality of designated message sections; and
sending the card between two or more parties, each party adding a new message in an unused message section of the card before sending the card on, so that messages are presented in the card in a desired sequence.

17. The method according to claim 16, further comprising the step of adding at least one of graphics or one or more pictures to the card as part of a greeting.
